(19) United States
(12) Patent Application Publication
(10) Pub. No.: US 2022/0304236 A1
(43) Pub. Date: Sep. 29, 2022

(54) A COMBINE HARVESTER AND A METHOD FOR THRESHING HARVESTED CROP MATERIAL

(71) Applicant: Jakob Sørensen IP ApS, Hammel (DK)

(72) Inventor: Jakob Balling Bro SØRENSEN, Hammel (DK)

(21) Appl. No.: 17/618,271

(22) PCT Filed: Jun. 22, 2020
(86) PCT No.: PCT/DK2020/050180

§ 371 Date: Dec. 10, 2021

(30) Foreign Application Priority Data
Jun. 26, 2019 (DK) PA 2019 70410

(51) Int. Cl. A01D 61/02; A01F 12/10

(52) U.S. Cl. CPC A01D 61/02; A01F 12/10

(57) ABSTRACT

Disclosed is a combine harvester (1) comprising, a crop material conveyor (2) arranged to convey harvested crop material (3) in a conveying direction (CD) towards a threshing apparatus (4). The threshing apparatus (4) comprising a thresher plate (5) and a rotating thresher (6) arranged to rotate around a thresher rotation axis (7) 5 extending in a transverse direction in relation to the conveying direction (CD). The thresher plate (5) partly encircles the rotating thresher (6) such that the harvested crop material (3) is beat against the thresher plate (5) by the rotating thresher (6). An apex (8) of the crop material conveyor is arranged above the thresher rotation axis (7), so that the harvested crop material (3) is deposited to the threshing apparatus (4) from 10 above the thresher rotation axis (7).

### FIELD OF THE INVENTION

The invention relates to a combine harvester comprising a threshing apparatus. The invention further relates to a method for threshing harvested crop material.

### BACKGROUND OF THE INVENTION

Combine harvesters are widely used and they are important machinery within the field of agriculture for efficiently harvesting crop material. As the combine harvester drives along the field, the crop material is cut and conveyed by a conveying unit to a threshing unit, which usually comprises a part which rotates and a concave against which the harvested crop material is beat whereby the grains are released from the crop stalks. The grains, together with chaffs, straw pieces and other unwanted light material, are then usually conveyed towards a cleaning device for separating the unwanted material from the grain.

However, the mechanical configuration of the present threshing apparatus do not provide for an optimal threshing efficiency. Thus, threshing apparatus and combine harvesters according to the prior art are not particularly efficient.

Thus, it is an object of the present invention to provide for a more efficient combine harvester technique.

### THE INVENTION

The invention provides for a combine harvester comprising a crop material conveyor arranged to convey harvested crop material in a conveying direction towards a threshing apparatus. The threshing apparatus comprises a thresher plate and a rotating thresher arranged to rotate around a thresher rotation axis which extends in a transverse direction in relation to the conveying direction. The thresher plate partly encircles the rotating thresher such that the harvested crop material is beat against the thresher plate by the rotating thresher. An apex of the crop material conveyor is arranged above the thresher rotation axis, so that the harvested crop material is deposited to the threshing apparatus from above the thresher rotation axis.

The thresher plate is usually positioned below the rotating thresher and to efficiently deposit the crop material from the threshing apparatus, the thresher plate may not extend too high up on the back side of the rotating thresher. Because of the way the present crop material conveyors deposit the crop material, it is not possible to raise the front side of the thresher plate.

Thus, it is advantageous to provide a combine harvester wherein the crop material conveyor is arranged such that the harvested crop material is deposited to the threshing apparatus from above the thresher rotation axis in that the crop material is deposited from a higher point which allows for a thresher plate which encircles a larger portion of the rotating thresher. And it is advantageous if the thresher plate encircles a larger portion of the rotating thresher in that the threshing area between the rotating part and the thresher plate is increased whereby the threshing efficiency is improved.

It should be noted that orientation terms such as “horizontal”, “vertical”, “below”, “above”, “up” and “down” should be understood in relation to the combine harvester in normal operation, i.e. when the combine harvester is operating normally on a substantially level surface.

In this context, the term “crop material conveyor” should be understood as a belt drive, chain drive, screw conveyor, slat type conveyor or any other type of conveyor mechanism for conveying the harvested crop material from a lower region of the combine harvester where the reaped crop material enters and to a threshing apparatus. And the term “crop material” should be understood as rye, maize, barley, rapeseed, corn and other type of crops which may be harvested by the use of a combine harvester.

Also, in this context, the term “apex” should be understood as a top part of the crop material conveyor, for example the point of sharpest curvature at the top part of the conveyor at which point the conveying motion shifts from an upwards motion to a downwards motion.

In this context, the term “thresher plate” should be understood as a plate or meshed grill which to some degree encircles the rotating thresher and which is designed to support the harvested crop material being threshed and also for withstanding the loads arising from the threshing process. Such a thresher plate may for example comprise apertures (e.g. circular or rectangular) for allowing grains and small pieces of straw to fall therethrough. The thresher plate may be designed in a substantially concave shape and such a thresher plate in a combine harvester is also commonly referred to as “a concave” due to its characteristic curved, concave shape.

It should be emphasized that the term “rotating thresher” is to be understood as a drum or cylinder comprising teeth, rasp bars, spikes or other kind of protrusions for beating the crop material as the rotating thresher rotates around a thresher rotation axis. Such a rotating thresher, which rotates around a thresher rotating axis extending in a transverse direction in relation to the conveying direction is also referred to as a “tangential thresher”.

In an aspect of the invention, the thresher plate encircles said rotating thresher in an arc angle of between 120 and 250 degrees, preferably between 140 and 230 degrees and most preferably between 160 and 210 degrees.

If the arc angle is too small, the threshing area may become too small whereby the threshing efficiency is reduced. If the arc angle is too large, the thresher plate may enclose too much of the rotating thresher whereby the threshing apparatus may become overloaded such that the threshed crop material may get stuck in the threshing apparatus as it may not efficiently be transported away. Therefore, the above-mentioned ranges represent an advantageous relationship between efficiency and functionality.

In an aspect of the invention, the crop material conveyor is arranged to form a conveyor angle of between −20 and +20 degrees, preferably between −10 and +10 degrees between the conveying direction and a vertical plane.

If the conveyor angle is too small (numerical/absolute value of the angle), the conveying direction may be too steep whereby the harvested crop material may not efficiently be deposited from the crop material conveyor to the threshing apparatus. If if the conveyor angle is too large (numerical/absolute value of the angle), the horizontal extension of the crop material conveyor may be too large and thereby take too much space and it may be difficult to deposit the crop material to the threshing apparatus from a point above the rotation axis. Therefore, the above-mentioned ranges represent an advantageous relationship between functionality and space-consumption.

It should be noted, that the conveyor angle is the angle between a vertical plane and the conveying direction.

In an aspect of the invention, a grain tank extends at least partly under the threshing apparatus.

It is advantageous if the grain tank extends at least partly under the threshing apparatus in that in that the grain tank may intercept any grain which may fall through the thresher plate. And this is advantageous in that the grain falling through the thresher plate may be collected directly in the grain instead of potentially being wasted. Hereby, the efficiency of the combine harvester is improved.

In an aspect of the invention, the crop material conveyor is arranged with a front side facing the front of the combine harvester and a back side facing the back of the combine harvester. The crop material conveyor is arranged to convey the harvested crop material along the front side.

It is advantageous to convey the crop material on the front side of the conveyor, as it becomes easier to deposit the crop material from a point above the thresher rotation axis. Furthermore, when delivering the crop material from a point above the thresher rotation axis and doing so from the front side of the conveyor provides for a more smooth transition between the crop material conveyor and the threshing apparatus. A smooth transition between the crop material conveyor and the threshing apparatus is advantageous because the crops are not destroyed and broken due to abrupt shift of direction of travel as it is transferred from the conveyor to the thresher. Furthermore, it is advantageous to provide for a more smooth transition in that the mass acceleration, and thereby the loads on the mechanical components, is reduced. A smooth transition is in this context understood such that a “tangent-tangent” transition is achieved, i.e. a tangent at the point at which the crops leave the conveyor is also a tangent at the point of entry into the threshing apparatus such that abrupt bending of the crops is minimized.

In an aspect of the invention, the back side forms part of a back side channel.

It is advantageous if the back side of the crop material conveyor forms a back side channel in that stones, which may have been collected together with the crop material, may slide down the back side channel by means of gravity and thereby naturally be sorted away from the harvested crop material.

The term “backside channel” should be understood as a conduit, tube, channel or other kind of guiding section in which separated stones or other unwanted, heavy objects may fall or slide through.

In an aspect of the invention, the combine harvester comprises a stone container arranged at the lower end of said crop material conveyor

It is advantageous to provide the combine harvester with a stone container in that stones do not proceed into the fast rotating and vibrating parts of the combine harvester which may be destroyed by the stones. Depending on the underlying ground, the stone container may have to be emptied at regular interval during harvesting and it is therefore important that the process of emptying the stone container does not take too much time, e.g. because of having to climb up on the combine harvester in order to empty the stone container. Therefore, it is advantageous to arrange the stone container at the lower end of the crop material conveyor in that the stone container is thereby arranged closer to the ground so that the operator may easier access and empty the stone container e.g. from a standing position on the ground.

In this context, the term “lower end” should be understood as the material pick up end of the crop material conveyor and which is closest to the underlying ground when the combine harvester is in normal operating position.

In an aspect of the invention, the vertical distance between the apex and the thresher rotation axis is between 10 mm and 500 mm, preferably between 70 mm and 350 mm, and most preferably between 120 mm and 250 mm.

If the vertical distance between the apex and the thresher rotation axis is too large, the height limitation of the combine harvester may be exceeded, and it may be too difficult to deposit the crop material onto the threshing apparatus. And if the distance is too small, the harvested crop material may be deposited too low onto the threshing apparatus which puts limitations on the thresher plate size and therefore the threshing efficiency. Thus, the above-mentioned ranges represent an advantageous relationship between size limitation, functionality and threshing efficiency.

In an aspect of the invention, a front edge of the thresher plate facing the crop material conveyor is arranged in a front edge angle of between 50 and 150 degree, preferably between 60 and 140 degrees and most preferably between 70 and 130 degrees in relation to a vertical plane.

If the front edge angle in relation to a vertical plane is too small, the thresher plate may encircle too much of the front side of the rotating thresher whereby it is difficult to provide for a smooth transition between the crop material conveyor to the threshing apparatus. And if the front edge angle is too large, the size of the thresher plate, and thereby threshing efficiency, may be reduced. Thus, the above-mentioned ranges represent an advantageous relationship between functionality and efficiency.

In an aspect of the invention, the thresher plate is positioned below the rotating thresher.

The thresher plate provides for a supporting surface against which the crop material is beat as the rotating thresher rotates. And if the thresher plate is positioned below the rotating thresher, it is easier to form a continuous flow of crop material in that the thresher plate supports the crop material in vertical direction while the rotating thresher beats and conveys the crop material backwards.

The invention further relates to a method for threshing harvested crop material. The method comprises the steps of:
conveying the harvested crop material via a crop material conveyor in a conveying direction towards a threshing apparatus,
depositing the harvested crop material from an apex of the crop material conveyor. The apex being arranged above a thresher rotation axis such that the harvested crop material is deposited to the threshing apparatus from above the thresher rotation axis.

Using the invention for threshing harvested crop material according to the above-mentioned method is advantageous in that the harvested crop material is threshed more efficiently because depositing the harvested crop material from above the thresher rotation axis enables the use of a larger thresher plate whereby the efficiency of the combine harvester is increased.

### FIGURES

The invention will be described in the following with reference to the figures in which

FIG. 1. illustrates a combine harvester comprising a slanted crop material conveyor,

FIG. 2 illustrates an embodiment of the combine harvester comprising a substantially vertical crop material conveyor.

### DETAILED DESCRIPTION

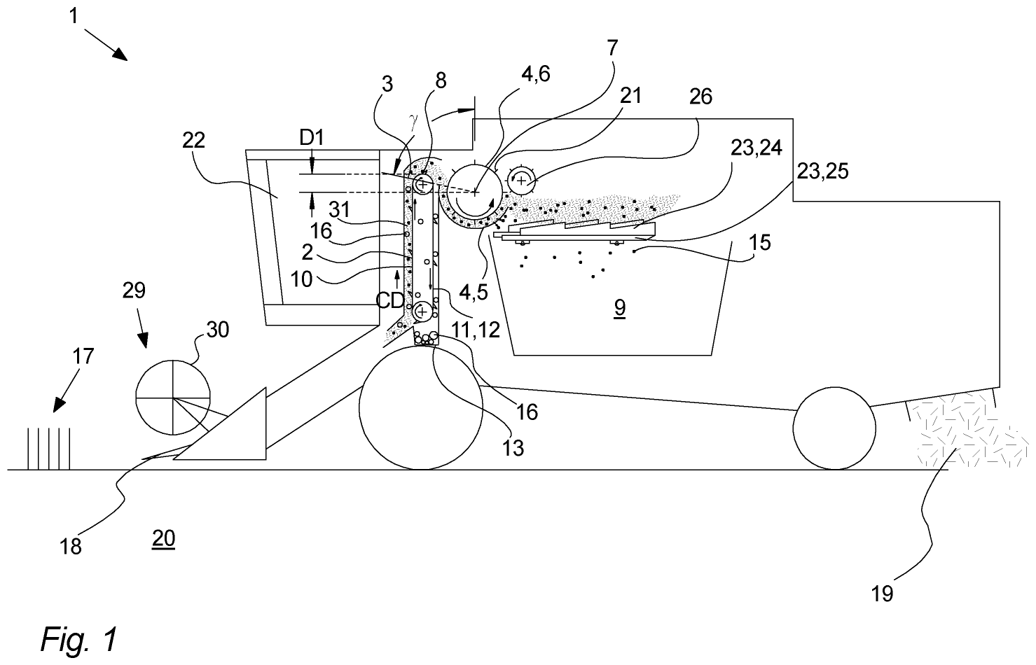

FIG. 1 illustrates a combine harvester 1 comprising a slanted crop material conveyor 2. The figure illustrates one embodiment of the invention as to how the combine harvester 1 may collect the crops 17 and thresh the crop material. As the combine harvester 1 drives along the field on the underlying ground 20, the crops 17 are oriented and directed by the reel bar 30 towards the cutter bar 18 of the header 29 whereby the crop material is cut. The header 29 may comprise augers (not shown) which convey the cut crops 17 towards the center of the header 29 such that the material is gathered at the center and conveyed to the crop material conveyor 2. This figure illustrates only the part of the crop material conveyor 2 preceding the threshing apparatus. However, the crop material conveyor 2 may also extend down to the cutter bar 18 for receiving the cut crop material 3 directly or there could be an intermediate conveyor positioned in between the cutter bar 18 and the crop material conveyor 2. The harvested crop material 3 may then be conveyed in a conveying direction CD upwards towards the threshing apparatus 4 onto which it is deposited from an apex of the conveyor 2 and from a vertical distance D1 between the apex 8 and thresher rotation axis 7 The threshing apparatus comprises a rotating thresher 6 and a thresher plate 5. The rotating thresher 6 beats and threshes the crop material against the thresher plate 5 such that crop yields 15 are released from the stalks.

In this embodiment, the vertical distance D1 is 150 mm. However, in another embodiment, the distance D1 could be 50 mm, 200 mm or larger or smaller.

In this embodiment the crop material conveyor 2 is arranged as two parallel-running chains driven by conveyor drivers 27. In this embodiment, the conveyor drivers 27 are sprocket wheels, but in another embodiment the conveyor drivers 27 could be pulleys, belt drive, gear mechanism or other kind of mechanism for driving the crop material conveyor 2. The conveyor drivers 27 could be driven by a dedicated motor or connected to the combine harvester engine (not shown) either directly or via a gearing to provide a gearing ratio between the engine rotation speed and the rotation speed of the conveyor drivers 27.

Crop material drivers 28 may extend between the chains such as to drive the crop material upwards. In this embodiment the crop material drivers 28 are simple steel plates such that the crop material drivers 28 may carry the crop material. However, in another embodiment, the crop material drivers 28 could be spikes, cups, paddles, teeth or other kind of crop material driver for meshing with the crop material 3 such that it is carried in the conveying direction CD.

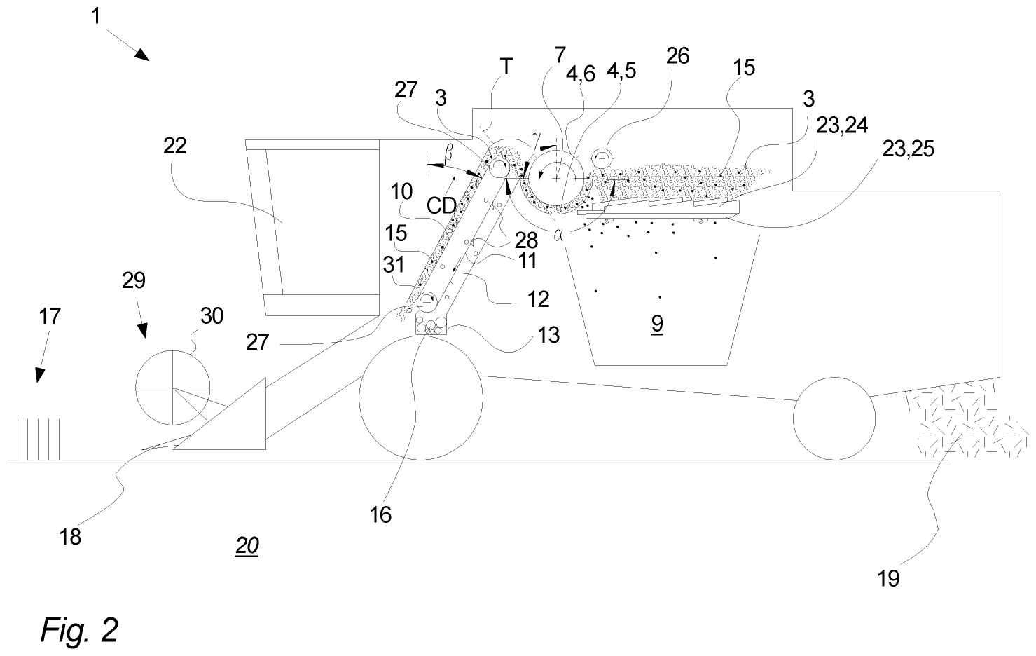

In this embodiment, the crop material conveyor 2 is arranged at a conveyor angle β of 0 degrees such that the harvested crop material 3 may be conveyed substantially vertically (i.e. β=0). However, in another embodiment, the crop material conveyor 2 could be arranged in a conveyor angle β of −20 degrees or +20 degrees (see FIG. 2), or at larger or smaller angles. At the upper part of the crop material conveyor 2 the harvested crop material 3 is deposited at the threshing apparatus 4.

As the harvested crop material passes from the crop material transporter 2 to the beating apparatus 4, stones, which have a larger density than the crop material, may naturally fall downwards and along the backside channel 12 which channels the stones into the stone container 13. The crop material beaters 21 may also aid in the separation of stones in that they may strike the stone 16 such that it is directed backwards and towards the backside channel 12. The stone container 13 may comprise a sensor (not shown) and an alarming unit (not shown) for alerting the operator when the stone container 13 is filled with stones. The sensor unit could be any type of sensor such as acoustic, optic, ultrasonic or any other suitable sensor for sensing if the stone container is filled. The sensor could communicate with a receiving unit located e.g. in the driver cabin 22 and such that the operator may be alerted by means of e.g. audio signal, visual signal from a user interface, an alerting alarm or other kind of alerter.

The stone container 13 may also comprise a hatch (not shown) such that the operator may empty the stone container regularly, e.g. when the alarming unit alerts the operator to do so. In this embodiment, the stone container 13 is arranged at a lower position of the crop material conveyor 2 such that the operator may reach the stone container 13 from the ground without having to climb up on the combine harvester. This is convenient for the operator as opposed to other alternatives where the stone collector may be arranged high above the ground.

Since the crop material conveyor 2 may comprise parallel-running chains wherein crop material drivers 28 extend between the chains with a regular interval, it is possible that stones 16 may be located in the space between the front side 10 and back side 11. However, a shielding plate (not shown), which could be positioned between the front side of the crop conveyor 10 and the back side channel 12, may prevent the stones 16 from moving back into the front side channel 31.

In this embodiment, the harvested crop material 3 is conveyed along the front side 10 of the crop material conveyor. However, in another embodiment, the crop material 3 could be conveyed along the back side channel 12 of the crop material conveyor, i.e. the direction of rotation of the conveyor wheels 27 would be reversed such that they would run in a counter-clockwise direction (i.e. the reverse direction in relation to the clockwise rotation as shown in FIG. 1 and FIG. 2).

To reduce the bending of the crop material stalks as the crop material passes from the crop material conveyor 3 to the threshing apparatus 4 the conveyor angle β and the front edge angle γ may be selected such that the tangent T at the point of separation i.e. at the point at which the crop material conveyor 2 “slips” the crop material 3, is also a tangent T at the point of entry in the threshing apparatus 4. However, it should be noted that this does not restrict the invention to a selection of front angle γ and conveyor angle β such that such a tangent line may be drawn. Any combination of front angle γ and conveyor angle β (and also arc angle α) may be combined depending on specific purposes.

In an embodiment, the diameter of the rotating thresher 6 may be adjusted so as to adjust the size of the gap between the crop material beaters 21 and the thresher plate This is advantageous in that the degree of beating may be adjusted to the specific crop material being harvested and threshed whereby the threshing efficiency may be increased.

In this embodiment, the thresher plate 5 is a meshed grill which is shaped as a concave and encircles the rotating thresher 6 in an arc angle α of 190 degrees. However, in another embodiment, the thresher plate 5 could encircle the rotating thresher 6 in an arc angle α of, for example, 120 or 180 degrees or smaller or greater arc angle α.

In this embodiment, the crop material beaters 21 are illustrated as teeth protruding from the circumference of the rotating thresher 6. Such teeth may be advantageous for threshing e.g. rice. However, in another embodiment, the crop material beater 21 comprises rasp bars for beating and conveying the crop material. The rasp bars may comprise serrations (not shown) for increasing the surface area and for easier engagement into the crop material for conveying it. The serrations may also be angled in relation to the conveying direction and the serrations of the rasp bars may alternate between left-handed and right-handed orientation such that the crop material is well distributed along the length of the threshing apparatus 4 and not consistently pushed to one side only.

The cleaning unit 23 is in this embodiment formed as a “walker-sieve” which comprises straw walkers 24 and sieves 25 integrated in one part. In another embodiment, the cleaning unit 23 could be formed by separate straw walkers 24 and sieves 25. Also, the cleaning unit may also comprise a blower (not shown) for generating an airflow up and through the sieves and/or straw walkers such that the separation of grain material from straw material and debris is aided. Such a blower could be an axial-flow fan, cross-flow fan, mixed flow fan, centrifugal blower, compressor or other type of device for generating an airflow.

The cleaned grain 15 (or other type of crop yield) may fall directly to a grain tank 9 which may be positioned below the threshing apparatus 4 and cleaning unit 23. The grain tank 9 may comprise augers (not shown) at the bottom of the grain tank 9 and extending in a longitudinal direction such that crop yield 15 is conveyed towards the front or the back of the combine harvester where a vertical auger may convey the grain upwards and discharge the grain 15 from the grain tank 9 and onto e.g. a tractor driving next to the combine harvester for receiving the grain 15. The combine harvester may also unload the grain 15 directly into a stationary grain tank after the harvesting is completed.

In an embodiment of the invention, the thresher plate 5 may be adjustable in the vertical direction such that the clearance between the concave 5 and the rotating thresher 6 can be adjusted depending on the type of crop, rate of material feed, degree of threshing or other parameters which influence the threshing efficiency.

FIG. 2 illustrates a combine harvester 1 comprising a substantially vertical crop material conveyor 2.

A blower (not shown) is arranged to establish an adequate flow of air such that the debris 12 are separated from the grains 11. The blower could be a radial flow fan, axial flow fan, cross-flow fan, mixed flow fan, centrifugal blower, compressor or any other type of apparatus which may be used for generating an airflow. Furthermore, the blower could establish the airflow continuously or in portions/pulses.

For improving the discharging of the crop material from the threshing apparatus 4, the combine harvester may comprise a rear beater 27 which aids in pulling the crop material 3 away from the threshing apparatus 27. The rear beater 26 may also aid in streamlining and evening out the crop material being discharged from the threshing apparatus 4 such that it is easier cleaned in the cleaning unit 23.

After threshing and cleaning the harvested crop material 3, the straw material 19, which at this point should not contain any grain or other kind of crop yield, is discharged from the rear part of combine harvester 1. The straw material 19 may be discharged directly onto the ground after being cut and chopped into smaller pieces by a straw material chopper (not shown) or it may be baled up prior to being discharged from the combine harvester. The straw material 19 may also be baled up afterwards by a machine suitable for this. The baled up straw material 19 may then be used for animal bedding, building insulation or for other purposes.

In this embodiment, the arc angle α is substantially 180 degrees. However, in another embodiment, the arc angle α could be 120 degrees or it could be 220 degrees or smaller or larger.

The invention has been exemplified above with reference to specific examples of arc angle α, conveyor angle β, crop material conveyor 2, rotating thresher 6 and other. However, it should be understood that the invention is not limited to the particular examples described above but may be designed and altered in a multitude of varieties within the scope of the invention as specified in the claims.

### LIST

1. Combine harvester
2. Crop material conveyor
3. Harvested crop material
4. Threshing apparatus
5. Thresher plate
6. Rotating thresher
7. Thresher rotation axis
8. Apex of crop material conveyor
9. Grain tank
10. Front side of crop material conveyor
11. Back side of crop material conveyor
12. Back side channel
13. Stone container
14. Front edge of thresher plate
15. Grain
16. Stone
17. Crops
18. Cutter bar
19. Straw material
20. Ground
21. Crop material beater
22. Driver cabin
23. Cleaning unit
24. Straw walkers
25. Sieves
26. Rear beater
27. Conveyor drivers
28. Crop material driver
29. Header
30. Reel bar
31. Front side channel
α. Arc angle
β. Conveyor angle
γ. Front edge angle
CD. Conveying direction
D1. Vertical distance

1. A combine harvester comprising,
a crop material conveyor arranged to convey harvested crop material in a conveying direction towards a threshing apparatus,
said threshing apparatus comprising a thresher plate and a rotating thresher arranged to rotate around a thresher rotation axis extending in a transverse direction in relation to said conveying direction, wherein said thresher plate partly encircles said rotating thresher such that said harvested crop material is beat against said thresher plate by said rotating thresher;
wherein an apex of said crop material conveyor is arranged above said thresher rotation axis, so that said harvested crop material is deposited to said threshing apparatus from above said thresher rotation axis.

2. The combine harvester according to claim 1, wherein said thresher plate encircles said rotating thresher in an arc angle of between 120 and 250 degrees.

3. The combine harvester according to claim 1, wherein said crop material conveyor is arranged to form a conveyor angle of between −20 and +20 degrees.

4. The combine harvester according to claim 1, wherein a grain tank extends at least partly under said threshing apparatus.

5. The combine harvester according to claim 1, wherein said crop material conveyor is arranged with a front side facing the front of the combine harvester and a back side facing the back of said combine harvester, and wherein said crop material conveyor is arranged to convey said harvested crop material along said front side.

6. The combine harvester according to claim 5, wherein said back side forms part of a back side channel.

7. The combine harvester according to claim 1, wherein said combine harvester comprises a stone container arranged at the lower end of said crop material conveyor.

8. The combine harvester according to claim 1, wherein a vertical distance between said apex and said thresher rotation axis is between 10 mm and 500 mm.

9. The combine harvester according to claim 1, wherein a front edge of said thresher plate facing said crop material conveyor is arranged in a front edge angle of between 50 and 150 degrees.

10. A method for threshing harvested crop material in a combine harvester, said method comprising the steps of:
conveying said harvested crop material via a crop material conveyor in a conveying direction towards a threshing apparatus,
depositing said harvested crop material from an apex of said crop material conveyor, said apex being arranged above a thresher rotation axis such that said harvested crop material is deposited to said threshing apparatus from above said thresher rotation axis.

11. The combine harvester according to claim 1, wherein said thresher plate encircles said rotating thresher in an arc angle of between 140 and 230 degrees.

12. The combine harvester according to claim 1, wherein said thresher plate encircles said rotating thresher in an arc angle of between 160 and 210 degrees.

13. The combine harvester according to claim 1, wherein said crop material conveyor is arranged to form a conveyor angle of between −10 and +10 degrees.

14. The combine harvester according to claim 1, wherein a vertical distance between said apex and said thresher rotation axis is between 70 mm and 350 mm.

15. The combine harvester according to claim 1, wherein a vertical distance between said apex and said thresher rotation axis is between 120 mm and 250 mm.

16. The combine harvester according to claim 1, wherein a front edge of said thresher plate facing said crop material conveyor is arranged in a front edge angle of between 60 and 140 degrees.

17. The combine harvester according to claim 1, wherein a front edge of said thresher plate facing said crop material conveyor is arranged in a front edge angle of between 70 and 130 degrees in relation to a vertical plane.
